(19) United States
(12) Patent Application Publication
(10) Pub. No.: US 2016/0292010 A1
(43) Pub. Date: Oct. 6, 2016

(54) ELECTRONIC DEVICE THAT ENSURES SIMPLIFIED COMPETITION AVOIDING CONTROL, METHOD AND RECORDING MEDIUM

(71) Applicant: KYOCERA Document Solutions Inc., Osaka (JP)

(72) Inventor: Yuya MAESONO, Osaka (JP)

(73) Assignee: KYOCERA Document Solutions Inc., Osaka (JP)

(21) Appl. No.: 15/051,152

(22) Filed: Feb. 23, 2016

(30) Foreign Application Priority Data
Mar. 31, 2015 (JP) 2015-070633

(51) Int. Cl. G06F 9/50

(52) U.S. Cl. CPC G06F 9/5038

(57) ABSTRACT

An electronic device includes a memory and a processor. The memory has a storage region and stores a control program to control the electronic device in the storage region. The processor executes the control program, when the control program is executed, the processor operates; an access counter that has a specific initial value and avoids an access competition to an access object accessed from a plurality of tasks; a high priority level task that increments the access counter when starting an access to the access object, and decrements the access counter when completing the access to the access object; and a low priority level task that accesses the access object when the access counter has the specific initial value.

### INCORPORATION BY REFERENCE

This application is based upon, and claims the benefit of priority from, corresponding Japanese Patent Application No. 2015-070633 filed in the Japan Patent Office on Mar. 31, 2015, the entire contents of which are incorporated herein by reference.

### BACKGROUND

Unless otherwise indicated herein, the description in this section is not prior art to the claims in this application and is not admitted to be prior art by inclusion in this section.

There have been various methods are contrived to avoid generating a competition by simultaneous accesses from a plurality of processes to an access object, for example, a specific region on a memory. In the following, these methods are referred to as competition avoiding controls.

For example, on a typical image forming apparatus including a printer function and a copy function, when both functions are used at the same time, to avoid an access competition to an image forming unit used among both functions, there is proposed a technique that gives a higher priority level to the image forming unit to the copy function than the printer function.

For example, there is proposed a technique that determines priority levels to a plurality of input ports in advance, and when a competition to an output port occurs, permits an input from the input port with the best priority level to access the output port first.

As a control using the number of accesses, there is proposed, for example, a technique that counts the number of accesses to a file or a folder, and then corresponding to an amount of the number of accesses, adjusts an order that indicates the respective folders on a screen.

### SUMMARY

An electronic device according to an aspect of the disclosure includes a memory and a processor. The memory has a storage region and stores a control program to control the electronic device in the storage region. The processor executes the control program, when the control program is executed, the processor operates; an access counter that has a specific initial value and avoids an access competition to an access object accessed from a plurality of tasks; a high priority level task that increments the access counter when starting an access to the access object, and decrements the access counter when completing the access to the access object; and a low priority level task that accesses the access object when the access counter has the specific initial value.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates an electronic device according to an embodiment of the disclosure;

FIG. 2 illustrates a process that confirms a value of an access counter using a polling to execute a competition avoiding control according to the embodiment;

FIG. 3 illustrates a process that confirms the value of the access counter using an event semaphore to execute the competition avoiding control according to the embodiment; and

FIG. 4 illustrates a word of caution when executing the competition avoiding control using the event semaphore according to the embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an embodiment of the disclosure using the drawings.

In the following, the description will be given of a file stored in a storage device such as a hard disk drive (HDD) as an exemplary access object where a plurality of accesses compete. The access object may be any as long as a resource that an electronic device has, not limited to the file.

In the following, the description will be given of avoiding an access competition regarding low priority level tasks and high priority level tasks. The high priority level task is, for example, a facsimile function on an image forming apparatus (MFP). The facsimile function has a limitation that the facsimile function has to return a response to the others within a certain period of time. The low priority level task is, for example, a copy function and a printing function on the image forming apparatus. Thus, for each task, a priority level is predetermined corresponding to features such as a limitation about a corresponding function.

### Outline

First, a description will be given of an outline of the disclosure.

In the disclosure, as described above, instead of using a plurality of flags to execute an access control to avoid the competition by a plurality of accesses, an access counter is used to count the number of accesses to the access object by the high priority level processes, that is, the processes that should not be late by an access hindrance from the low priority level processes.

The value of the access counter is set at “0” (specific initial value) at an initial state. This means that there is no high priority level process that is accessing the access object.

On this access counter, when the high priority level process accesses the access object, the high priority level process starts the access after incrementing the access counter, and at the point when terminating the access, decrements the access counter.

Even if there are a plurality of high priority level processes, the plurality of high priority level processes increment and decrement the value of one access counter.

Then, the low priority level process refers to the access counter before starting the access to the access object. And if the value of the access counter is a positive number (not specific initial value), the low priority level process determines that the high priority level process is accessing the access object and does not execute the access to the access object.

When the low priority level process refers to the access counter before starting the access to the access object, if the value of the access counter is “0,” the low priority level process determines that the high priority level process is not accessing the access object and accesses the access object.

Thus, the low priority level process may not consider the number of the high priority level processes that are currently accessing the access object and may determine only whether or not the value of the access counter is positive number to determine whether or not the low priority level process is permitted to access the access object. This ensures simplified competition avoiding control compared to confirming all of the many flags.

In order for the low priority level process to access the access object, as a method to confirm that the value of the access counter became “0,” there are, for example, a method using a polling or a method using an event semaphore.

The details of the method using the polling and the method using the event semaphore are described below. Ordinary general differences between a semaphore and the event semaphore are also described later.

The outline of the disclosure has been described above.

### Semaphore and Event Semaphore

Next, a description will be given of a difference between an access control method typically referred to as a semaphore and the event semaphore.

When using the semaphore for the access control, for example, if a task A takes the semaphore first, a task B takes the semaphore next, and then a task C takes the semaphore next, the task A starts the process to the access object first, and the task B and the task C go into a waiting state of the semaphore.

After the task A completed the process and released the semaphore, among the task B and the task C that are waiting for the semaphore, the task B that took the semaphore earlier starts the process to the access object. The task C is still waiting for the semaphore.

After the task B completed the process to the access object and released the semaphore, the task C that was waiting for the semaphore executes the process to the access object.

Compared to this, when using the event semaphore for the access control, for example, if the task A takes the event semaphore first, the task B takes the event semaphore next, and then the task C takes the event semaphore next, the task A starts the process to the access object first, and the task B and the task C go into a waiting state of the event semaphore.

After the task A completed the process to the access object and released (flashed) the event semaphore, all the tasks that were waiting for the event semaphore, that is, the task B and the task C start the processes to the access object at once.

The difference between the access control method typically referred to as the semaphore, and the event semaphore have been described above. A function of the event semaphore may be achieved by an Operating System (OS).

### Configuration

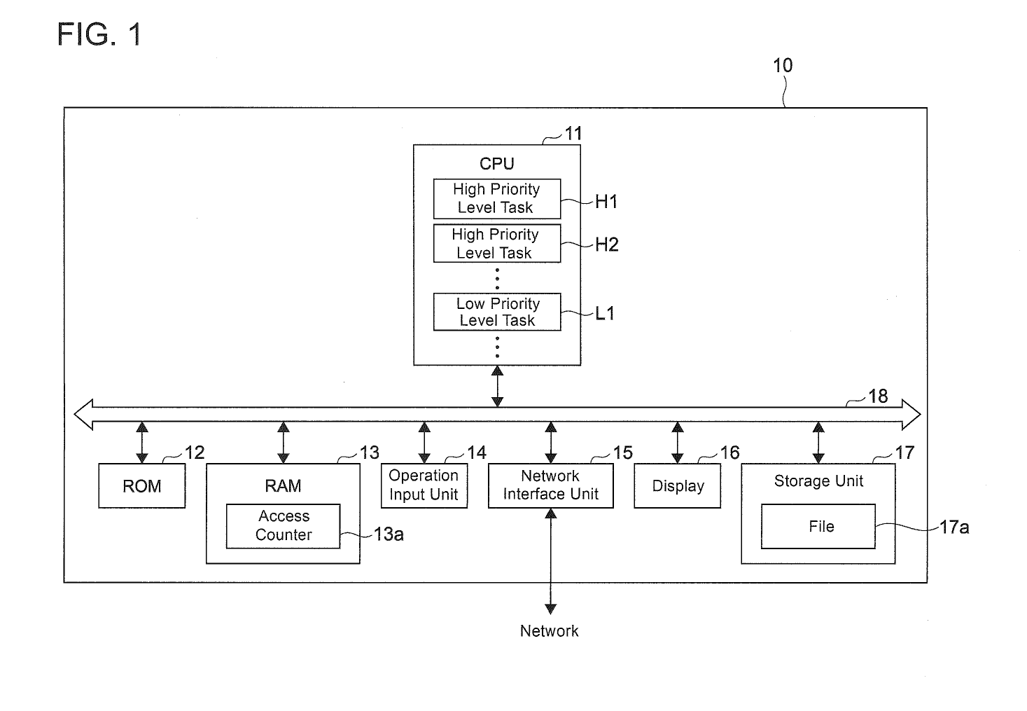

Next, a description will be given of the electronic device according to an embodiment of the disclosure. FIG. 1 illustrates an electronic device 10 according to the embodiment of the disclosure. In the following description, a concrete example where the electronic device 10 is configured to as a general-purpose computer is described.

As illustrated in FIG. 1, the electronic device 10 includes a Central Processing Unit (CPU) 11, a Read Only Memory (ROM) 12, a Random Access Memory (RAM) 13, an operation input unit 14, a network interface unit 15, a display 16, and a storage unit 17. These respective blocks are connected via a bus 18.

The ROM 12 has a region that fixedly stores a plurality of programs and data, such as firmware, to execute various processes.

The RAM 13 is used as a work area of the CPU 11, and temporarily holds OS, various applications in execution, various data in process, and an access counter 13a. The access counter 13a is used for the access control to prevent from the access competition by a plurality of tasks. Execution of the programs on the CPU 11, the CPU 11 can operate the access counter 13a to change the value of the access counter 13a.

The storage unit 17 is, for example, a Hard Disk Drive (HDD), a flash memory, or other non-volatile memory, which has a storage region. The storage unit 17 stores, in addition to OS, various applications, and various data, a file 17a that is accessed from the plurality of tasks.

The network interface unit 15, which is connected to a network 30 to exchange information with an image forming apparatus 20, collects information from the image forming apparatus 20 and provides collected information to the image forming apparatus 20.

The CPU 11 expands a program in the RAM 13, the program is corresponding to an instruction provided from the operation input unit 14 among a plurality of programs stored in the ROM 12 and the storage unit 17. The CPU 11 is a control unit that controls appropriately the display 16 and the storage unit 17 according to this expanded program.

On the CPU 11, programs are executed. This ensures function blocks such as a high priority level task H1, a high priority level task H2, and a low priority level task L1. In other words, when the programs are executed, the CPU 11 operates the function blocks such as, the high priority level task H1, the high priority level task H2, and the low priority level task L1. The numbers of the high priority level tasks and the low priority level tasks are not limited.

The high priority level task H1, the high priority level task H2, the low priority level task L1, and similar tasks refer to the access counter 13a on the RAM 13 to execute the access control, while these tasks access the file 17a in the storage unit 17 to execute the process.

The operation input unit 14 is, for example, a pointing device such as a computer mouse, a keyboard, a touch panel, and other operating device.

The display 16 is, for example, a liquid crystal display, an Electro-Luminescence (EL) display, a plasma display, a Cathode Ray Tube (CRT) display, or a similar display. The display 16 may be include in the electronic device 10 or may be externally connected.

The configuration of the electronic device 10 has been described above.

### Process Using Polling

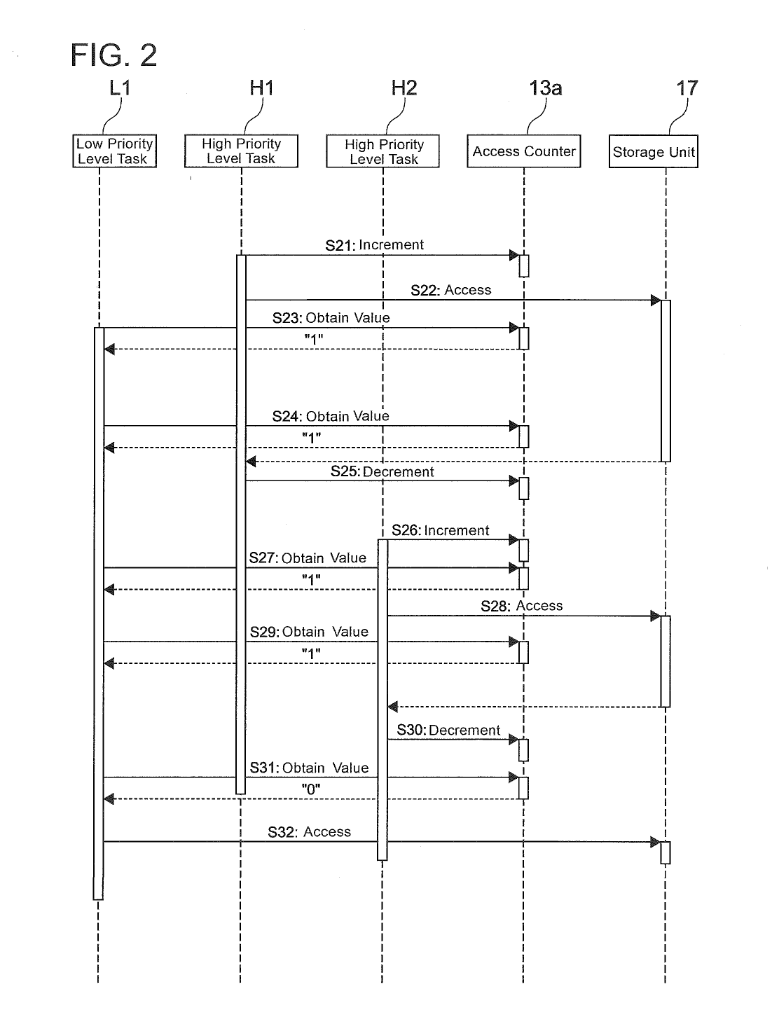

Next, a description will be given of a process that confirms the value of the access counter using the above-described polling to execute the competition avoiding control. FIG. 2 illustrates the process that confirms the value of the access counter using the polling to execute the competition avoiding control.

First, it is assumed that the high priority level task H1 accesses the file 17a in the storage unit 17. In this case, the high priority level task H1 increments the value of the access counter 13a (Step S21).

Next, the high priority level task H1 accesses the file 17a in the storage unit 17 (Step S22).

Next, it is assumed that the low priority level task L1 obtains the value of the access counter 13a to access the file 17a (Step S23). At this point of time, since the high priority level task H1 has already incremented the value of the access counter 13a, as the value of the access counter 13a, “1” is returned.

Since the positive number is returned as the value of the access counter 13a, the low priority level task L1 waits for the access to the file 17a.

After a lapse of a certain period of time from that the low priority level task L1 obtained the value of the access counter 13a, the low priority level task L1 obtains the value of the access counter 13a again (Step S24). Even at this point of time, since the high priority level task H1 remains to increment the value of the access counter 13a, as the value of the access counter 13a, “1” is returned.

Next, it is assumed that the high priority level task H1 completed the access process to the file 17a. The high priority level task H1 decrements the value of the access counter 13a (Step S25).

Next, it is assumed that the high priority level task H2 accesses the file 17a in the storage unit 17. In this case, the high priority level task H2 increments the value of the access counter 13a (Step S26).

Thus, between Step S25 and Step S26, the value of the access counter 13a is “0.” Accordingly, if the low priority level task L1 obtains the value of the access counter 13a at a timing between Step S25 and Step S26, the low priority level task can detect that the value is “0” to access the file 17a.

However, in an example illustrated in FIG. 2, since between Step S25 and Step S26, the low priority level task L1 is in a waiting state of the next polling timing, the low priority level task L1 cannot know that the value of the access counter 13a became “0” and cannot access the file 17a.

Next, it is assumed that the low priority level task L1 obtains the value of the access counter 13a (Step S27). At this point of time, because the value of the access counter 13a decremented by the high priority level task H1 is incremented again by the high priority level task H2 to be “1,” the low priority level task L1 has to wait to access the file 17a.

Next, the high priority level task H2 accesses the file 17a in the storage unit 17 (Step S28).

After a lapse of a certain period of time from that the low priority level task L1 obtained the value of the access counter 13a, the low priority level task L1 obtains the value of the access counter 13a again (Step S29). Even at this point of time, since the high priority level task H2 remains to increment the value of the access counter 13a, as the value of the access counter 13a, “1” is returned.

Next, it is assumed that the high priority level task H2 completed the access to the file 17a. The high priority level task H2 decrements the value of the access counter 13a (Step S30).

After a lapse of a certain period of time from that the low priority level task L1 obtained the value of the access counter 13a, the low priority level task L1 obtains the value of the access counter 13a again (Step S31). At this point of time, since the high priority level task H2 decremented the value of the access counter 13a, as the value of the access counter 13a, “0” is returned.

Since “0” is returned as the value of the access counter 13a, the low priority level task L1 accesses the file 17a (Step S32).

As described above, since the low priority level task L1 could not detect that the value of the access counter 13a had become “0” between Step S25 and Step S26, the low priority level task L1 had to wait to access the file 17a until Step S32.

If, at Step S30, from the high priority level task H2 decrements the value of the access counter 13a until the low priority level task L1 obtains the value of the access counter 13a, another high priority level task increments the value of the access counter 13a, the low priority level task L1 has to wait to access the file 17a for a further long period.

The process that confirms the value of the access counter using the polling to execute the competition avoiding control has been described above.

### Process Using Event Semaphore

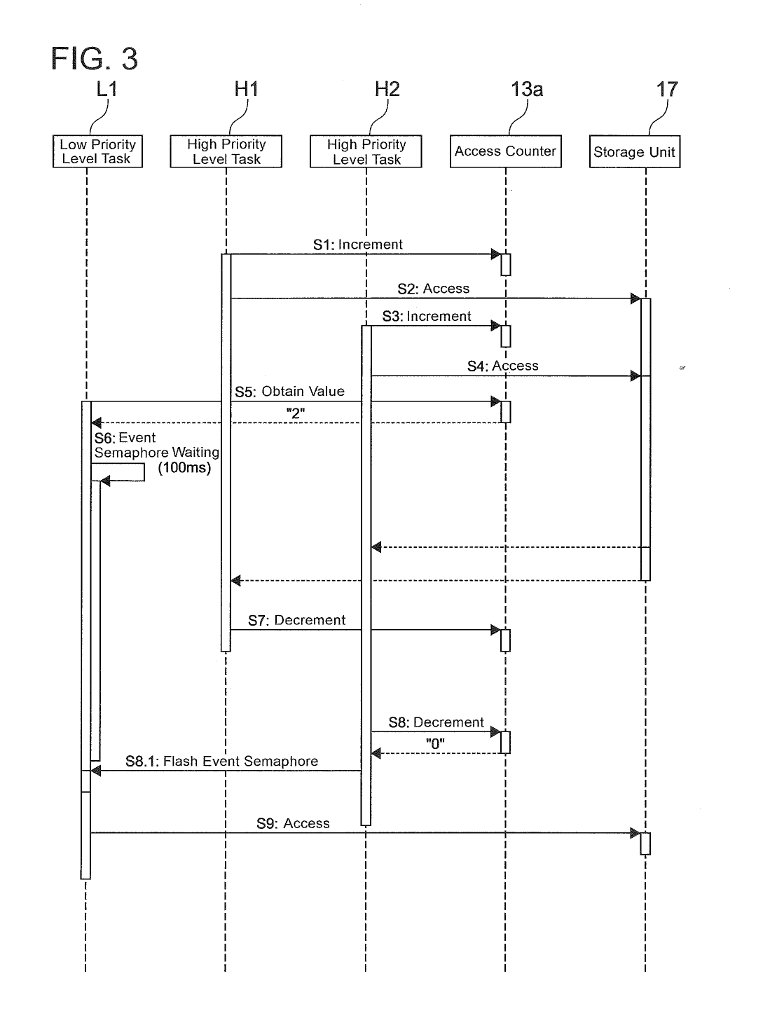

Next, a description will be given of a process that confirms the value of the access counter using the above-described event semaphore to execute the competition avoiding control. FIG. 3 illustrates the process that confirms the value of the access counter using the event semaphore to execute the competition avoiding control.

First, it is assumed that the high priority level task H1 accesses the file 17a in the storage unit 17. In this case, the high priority level task H1 increments the value of the access counter 13a (Step S1).

Next, the high priority level task H1 accesses the file 17a in the storage unit 17 (Step S2).

Next, it is assumed that the high priority level task H2 accesses the file 17a in the storage unit 17. In this case, the high priority level task H2 increments the value of the access counter 13a (Step S3).

Next, the high priority level task H2 accesses the file 17a in the storage unit 17 (Step S4).

Next, it is assumed that the low priority level task L1 accesses the file 17a in the storage unit 17. In this case, the low priority level task L1 obtains the value of the access counter 13a (Step S5). At the point where the low priority level task L1 obtains the value of the access counter 13a, since the two high priority level tasks H1 and H2 are accessing the file 17a, as the value of the access counter 13a, “2” is returned.

When the positive number is returned as the value of the access counter 13a, the low priority level task L1 specifies a timeout period, for example, 100 ms to go into an event semaphore waiting state (that is, temporary stop) (Step S6).

If while the low priority level task L1 is waiting for a flash of the event semaphore, the high priority level task H1 has completed the access to the file 17a, the high priority level task H1 decrements the value of the access counter 13a (Step S7).

After the decrement, the high priority level task H1 determines whether or not the value of the access counter 13a became “0” as a result of the decrement. Here, since the value of the access counter 13a is “1,” the competition avoiding control regarding the high priority level task H1 is completed.

If while the low priority level task L1 is waiting for the flash of the event semaphore, the high priority level task H2 has completed the access to the file 17a, the high priority level task H2 decrements the value of the access counter 13a (Step S8).

After the decrement, the high priority level task H2 determines whether or not the value of the access counter 13a became “0” as a result of the decrement. Here, since the value of the access counter 13a is “0,” the high priority level task H2 flashes the event semaphore (Step S8.1).

After the event semaphore was flashed, processes of all the low priority level tasks (here, low priority level task L1) that were waiting for the event semaphore are resumed to access the file 17a (Step S9).

The process that confirms the value of the access counter using the event semaphore to execute the competition avoiding control has been described above.

As described above, when using the event semaphore, compared to when using the polling, since at the point where the value of the access counter 13a became “0,” the flash of the event semaphore is executed immediately, the low priority level tasks that were waiting for the event semaphore can start accessing the file 17a immediately.

### Word of Caution When Using Event Semaphore

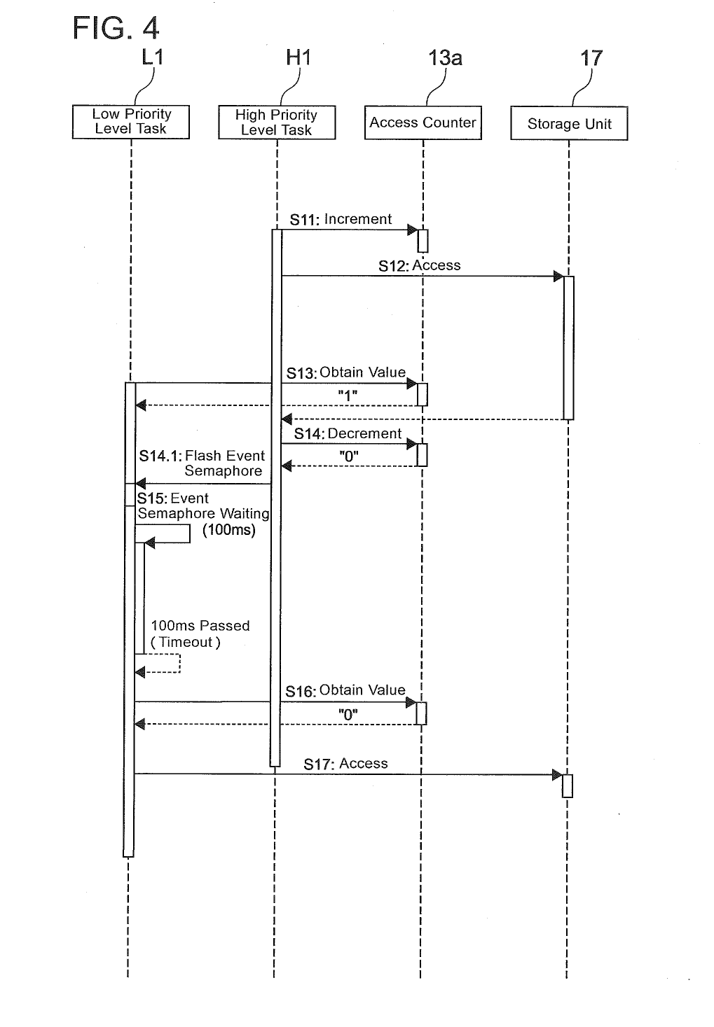

Next, a description will be given of a word of caution when executing the competition avoiding control using the event semaphore. FIG. 4 illustrates the word of caution when executing the competition avoiding control using the event semaphore.

First, it is assumed that the high priority level task H1 accesses the file 17a in the storage unit 17. In this case, the high priority level task H1 increments the value of the access counter 13a (Step S11).

Next, the high priority level task H1 accesses the file 17a in the storage unit 17 (Step S12).

Next, it is assumed that the low priority level task L1 accesses the file 17a in the storage unit 17. In this case, the low priority level task L1 obtains the value of the access counter 13a (Step S13). At the point where the low priority level task L1 obtains the value of the access counter 13a, since one high priority level task H1 is accessing the file 17a, as the value of the access counter 13a, “1” is returned.

Next, it is assumed that the high priority level task H1 completed the access process to the file 17a. In this case, the high priority level task H1 decrements the value of the access counter 13a (Step S14).

After the decrement, the high priority level task H1 determines whether or not the value of the access counter 13a became “0” as a result of the decrement. Here, since the value of the access counter 13a is “0,” the high priority level task H1 flashes the event semaphore (Step S14.1).

However, because the low priority level task L1 still has not gone into the event semaphore waiting state, the flash executed at Step S14.1 does not make any effect to the low priority level task L1. Accordingly, the low priority level task L1 cannot detect that the event semaphore was flashed.

Then, since the value obtained at Step S13 is the positive number, the low priority level task L1 goes into the event semaphore waiting state with specifying the timeout period (Step S15).

After a lapse of the timeout period, the low priority level task L1 obtains the value of the access counter 13a again (Step S16). Since the high priority level task H1 has completed the access to the file 17a, as the value of the access counter 13a, “0” is returned.

Since the value of the access counter 13a is “0,” the low priority level task L1 accesses the file 17a (Step S17).

As described above, if from the low priority level task L1 confirms the value of the access counter 13a until the low priority level task L1 goes into the event semaphore waiting state, the flash of the event semaphore is executed, the process of the low priority level task L1 that thereafter goes into the event semaphore waiting state will not be resumed until the next flash is executed.

However, until the high priority level task increments and decrements the value of the access counter 13a, the next flash is not executed.

Accordingly, when the low priority level task L1 goes into the event semaphore waiting state, the low priority level task L1 has to specify the timeout period of the event semaphore waiting and confirm the value of the access counter 13a for every timeout period reaches.

A method that the low priority level task L1 detects that the timeout period reached may be a configuration that receives a notification that the timeout period reached from OS.

The word of caution when executing the competition avoiding control using the event semaphore has been described above.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An electronic device, comprising:
a memory that has a storage region and stores a control program to control the electronic device in the storage region; and
a processor that executes the control program, when the control program is executed, the processor operates;
an access counter that has a specific initial value and avoids an access competition to an access object accessed from a plurality of tasks;
a high priority level task that increments the access counter when starting an access to the access object, and decrements the access counter when completing the access to the access object; and
a low priority level task that accesses the access object when the access counter has the specific initial value.

2. The electronic device according to claim 1,
wherein, when the control program is executed, the processor operates the low priority level task to poll the access counter to confirm the value of the access counter at specific time interval when the value of the access counter is not the specific initial value.

3. The electronic device according to claim 1,
wherein, when the control program is executed, the processor:
stops a process of the low priority level task temporarily when the low priority level task has entered to a state for waiting an event semaphore;
operates an operating system that resumes the process of the low priority level task that has been stopped temporarily, when the event semaphore is flashed;
operates the low priority level task to confirm the value of the access counter before accessing the access object, to enter a state where the low priority level task waits an event semaphore, when the value of the access counter is not the specific initial value, and to access the access object when the event semaphore is flashed;
operates the high priority level task to confirm the value of the access counter when completing the access to the access object and decrementing the access counter, and to flash the event semaphore when the value of the access counter is the specific initial value.

4. The electronic device according to claim 3,
wherein, when the control program is executed, the processor:
operates the low priority level task to specify a specific timeout period when entering the state for waiting the event semaphore;
operates the operating system to notify the low priority level task that the specific timeout period has passed, when the specific timeout period has passed,
operates the low priority level task to confirm the value of the access counter when the low priority level task is in the state for waiting the event semaphore and is notified that the specific timeout period has passed.

5. A non-transitory computer-readable recording medium storing a control program for controlling an electronic device, the control program causing a processor of the electronic device to operate:
an access counter that has a specific initial value and avoids an access competition to an access object accessed from a plurality of tasks;
a high priority level task that increments the access counter when starting an access to the access object, and decrements the access counter when completing the access to the access object; and
a low priority level task that accesses the access object when the access counter has the specific initial value.
